(19) United States
(12) Patent Application Publication
(10) Pub. No.: US 2011/0043497 A1
(43) Pub. Date: Feb. 24, 2011

(54) LED DISPLAY SYSTEM AND MODE-DETERMINING METHOD OF SAME

(75) Inventor: CHI-FENG HUANG, Hsinchu (TW)

Correspondence Address: WPAT, PC;INTELLECTUAL PROPERTY ATTORNEYS, 7225 BEVERLY ST., ANNANDALE, VA, 22003, US

(73) Assignee: ENE TECHNOLOGY INC., Hsinchu (TW)

(21) Appl. No.: 12/858,596

(22) Filed: Aug. 18, 2010

(30) Foreign Application Priority Data
Aug. 24, 2009 (TW) 098128414

(51) Int. Cl. G09G 5/00

(52) U.S. Cl. 345/204; 345/82

(57) ABSTRACT

A LED display system includes a display controller including an output port having a first output terminal and a second output terminal; a plurality of LED sets; and a plurality of driving circuits, coupled in series and coupled between the display controller and the plurality of LED sets, respectively. Each of the driving circuits includes a first signal-input terminal, a first signal-output terminal, a second signal-input terminal, and a second signal-output terminal, wherein the first signal-input terminal of a first one of the driving circuits is coupled to the first output terminal, the second signal-input terminal of the first one of the driving circuits is coupled to the second output terminal. The display controller asserts a transition period for switching the driving circuits from a first operation mode to a second operation mode by manipulating a first signal outputted to the driving circuits through the first output terminal.

### FIELD OF THE INVENTION

The present invention relates to a LED (Light Emitting Diode) display system, and more particularly to a driving circuit arranged in a LED display system. The present invention also relates to a mode-determining method of a LED display system for use with a driving circuit.

### BACKGROUND OF THE INVENTION

A LED display system is commonly applied to daily lives both indoors and outdoors due to enhanced power and illuminance of devices as well as mass production capability in factories. An example of the outdoor application of the LED display system is shown in FIG. 1, which is a diagram schematically depicting a display 110 of a LED display system disposed on a wall of a building 120. A similar LED display system may also be disposed on a wall in an indoor stadium as an example of the indoor application. The LED display system can be used for, for example, playing commercials or showing real-time information, e.g. live video of sports game.

FIG. 2 is a block diagram illustrating a LED display system with 6×2 resolution. There are twelve driving circuits 11˜16 and 21˜26 and twelve LED sets 211˜216 and 221˜226 included in a display 210, wherein the six driving circuits 11˜16 are coupled in series and the six LED sets 211˜216 are arranged in a first row; and the six driving circuits 21˜26 are coupled in series and the six LED sets 221˜226 are arranged in a second row. The color and brightness of the LED sets 211˜216 and 221˜226 are controlled by the driving circuits 11˜16 and 21˜26, respectively.

Moreover, the LED display system further includes a display controller 200, which includes a first output port (D1), a first input port (R1), a second output port (D2), and a second input port (R2). The first output port (D1) is connected to the driving circuit 11 and the first input port (R1) is connected to the driving circuit 16 so that a loop is constructed through the display controller 200 and the six driving circuits 11˜16 in the first row. Similarly, the second output port (D2) is connected to the driving circuit 21 and the second input port (R2) is connected to the driving circuit 26 so that another loop is constructed through the display controller 200 and the six driving circuits 21˜26 in the second row.

It is understood that a LED display system may have resolution up to 1024×768, and accordingly there would be 768 loops in the LED display system and in each of the loop there would be 1024 driving circuits coupled in series. Each of the LED sets 11˜16 and 21˜26 can be constructed by a single pixel or multiple pixels. A specified image can be shown on the display 210 under the cooperation of the display controller 200 and the driving circuits 11˜16 and 21˜26.

The driving circuits 11˜16 and 21˜26 are controlled by the display controller 200 to operate in one of different operation modes, for example a displaying mode, configuration mode, or detecting mode.

As depicted in FIG. 2, if the driving circuits 11˜16 and 21˜26 are in the displaying mode, six image data are sequentially outputted from the display controller 200 through the first output port (D1) and respectively shifted to the six driving circuits 11˜16 in a displaying cycle. Once all the six image data are respectively shifted to the six driving circuits 11˜16, the color and brightness of the LED sets 211˜216 can be respectively controlled by the driving circuits 11˜16 based on the corresponding six image data. Similarly, the color and brightness of the LED sets 221˜226 can be respectively controlled by the driving circuits 21˜26 based on another six corresponding image data which are outputted from the display controller 200 through the second output port (D2). Moreover, it is understood that the display controller needs to generate 1024 image data and shift the image data in one displaying cycle if there are 1024 driving circuits in a loop.

If the driving circuits 11˜16 and 21˜26 are in the configuration mode, six configuration data are sequentially outputted from the display controller 200 through the first output port (D1) and respectively shifted to the six driving circuits 11˜16 in a configuration cycle; wherein the configuration data can be used for initializing the driving circuits 11˜16 when the display controller 200 is activated. Specifically, the configuration data can be driving-circuit-control data, or analog driving-circuit-modulation signal. Once all the six configuration data are respectively shifted to the six driving circuits 11˜16, the LED sets 211˜216 or the driving circuits 11˜16 are accordingly set by the display controller 200 based on the six corresponding configuration data, respectively. Similarly, the LED sets 221˜226 or the driving circuits 21˜26 can be set by the display controller 200 based on another corresponding six configuration data in the same manner as described above.

If the driving circuits 11˜16 and 21˜26 are in the detecting mode, six status data are respectively generating by the six driving circuits 11˜16 as a result of detecting the six LED sets 211˜216 and the internal circuits of the six driving circuits 11˜16 in a detecting cycle. The six status data are then sequentially shifted to the display controller 200 through the first input port (R1) so that the operation conditions of the LED sets 211˜216 and the driving circuits 11˜16 can be realized by the display controller 200. Similarly, the operation conditions of the LED sets 221˜226 and the driving circuits 21˜26 can be realized by the display controller 200 in the same manner as described above.

It is to be understood that the operation modes of the driving circuits 11˜16 and 21˜26 need not be limited to the displaying mode, the configuration mode, and the detecting mode. The driving circuits 11˜16 and 21˜26 can be controlled by the display controller 200 to operate in other modes so as other functions are performed.

FIG. 3 is a diagram illustrating the connection between a display controller and driving circuits in a LED display system according to prior art. The first output port (D1) of the display controller 300 further includes a data-output terminal (do), a mode-output terminal (md), and a clock-output terminal (cko); wherein the data-output terminal (do) is used for outputting therethrough the image data or the configuration data, the mode-output terminal (md) is used for outputting therethrough a mode signal, and the clock-output terminal (cko) is used for outputting therethrough the clock signal. The first input port (R1) of the display controller 300 further includes a data-input terminal (ri) and a clock-input terminal (cki); wherein the data-input terminal (ri) is used for inputting therethrough the status data, and the clock-input terminal (cki) is used for inputting therethrough the clock signal.

In other words, if they are the six image data outputted from the data-output terminal (do) and respectively shifted to the six driving circuits 310˜360 in response to the clock signal which is outputted from the clock-output terminal (cko), the color and brightness of the LED sets 312˜362 are accordingly controlled. On the other hand, if they are the six configuration data outputted from the data-output terminal (do) and respectively shifted to the six driving circuits 310˜360 in response to the clock signal which is outputted from the clock-output terminal (cko), the LED sets 312˜362 and the driving circuits 310˜360 are accordingly set. In a further case that the six status data are generated by the six driving circuits 310˜360 and sequentially shifted to the display controller 300 through the data-input terminal (ri) in response to the clock signal which is outputted from the clock-output terminal (cko), the operation conditions of the LED sets 312˜362 and the driving circuits 310˜360 are accordingly realized by the display controller 300. Moreover, the mode signal outputted from the mode-output terminal (md) of the display controller 300 is used for switching the driving circuits 310˜360 from one operation mode to another operation mode.

FIG. 4 is a block diagram illustrating a driving circuit used in the LED display system according to prior art. The prior-art driving circuit 400, which is used for controlling an LED set 440, includes a shift register 410, a switching-control unit 402, a detection-control unit 404, a configuration-control unit 406, a clock buffer 470, and a mode-detecting unit 490. The switching-control unit 402 includes a display register 420 and a driving-current generating circuit 430. The detection-control unit 404 includes a status register 460 and a status-detecting circuit 450. The configuration-control unit 406 includes a configuration register 482 and an execution circuit 484. The LED set 440 includes a single LED or a plurality of LEDs emitting light with different colors, e.g. red, green, or blue light.

The driving circuit 400 further includes a data-input terminal (XSDI), a clock-input terminal (XCKI), a data-output terminal (XSDO), a clock-output terminal (XCKO), a mode-input terminal (XMDI), and a mode-output terminal (XMDO); wherein the data-input terminal (XSDI), the clock-input terminal (XCKI), and the mode-input terminal (XMDI) of the driving circuit 400 are electrically connected to the data-output terminal (XSDO), the clock-output terminal (XCKO), and the mode-output terminal (XMDO) of a previous-stage driving circuit, respectively. The data-input terminal (XSDI) of the driving circuit 400 is used for receiving image data, configuration data, or status data which is shifted thereto from the previous-stage driving circuit. The data-output terminal (XSDO) of the driving circuit 400 is used for outputting therethrough image data, configuration data, or status data to next-stage driving circuit. The mode-input terminal (XMDI) of the driving circuit 400 is used for receiving the mode signal which is transmitted thereto from the previous-stage driving circuit. The mode-output terminal (XMDO) of the driving circuit 400 is used for outputting the mode signal to the next-stage driving circuit. The clock-input terminal (XCKI) of the driving circuit 400 is used for receiving the clock signal which is transmitted thereto from the previous-stage driving circuit. The clock-output terminal (XCKO) of the driving circuit 400 is used for outputting therethrough the clock signal to the next-stage driving circuit.

The operation mode of the driving circuit 400 is determined by the mode-detecting unit 490 by detecting the mode signal which is inputted through the mode-input terminal (XMDI). If the driving circuit 400 is determined to operate in the displaying mode, the switching-control unit 402 is enabled by the mode-detecting unit 790 and the corresponding image data from the display controller is transmitted to the shift register 410. The corresponding image data is then sequentially transmitted to the display register 420 and the driving-current generating circuit 430. After the corresponding image data is transmitted to the driving-current generating circuit 430, a driving current is generated and outputted to the LED set 440 from the driving-current generating circuit 430 so as to control the color and brightness of the LED set 440.

If the driving circuit 400 is determined to operate in the configuration mode, the configuration-control unit 406 is enabled by the mode-detect unit 490 and the corresponding configuration data from the display controller is transmitted to the shift register 410. The corresponding configuration data is then sequentially transmitted to the configuration register 482 and the execution circuit 484. After the configuration data is transmitted to the execution circuit 484, corresponding setting operations are performed on the driving circuit 400 by the execution circuit 484.

If the driving circuit 400 is determined to operate in the detect mode, the detection-control unit 404 is enabled by the mode-detecting unit 490 and the corresponding status data is generated by the status-detect circuit 450, wherein the corresponding status data can be obtained as a result of an open-circuit or short-circuit detection of the LED set 440, or temperature or error detections of the driving circuit 400. The corresponding status data is then sequentially transmitted to the status register 460 and the shift register 410. After the status data is transmitted to the display controller through the data-output terminal (XSDO) of the driving circuit 400, the operation conditions of the LED set 440 and the driving circuit 400 are realized by the display controller.

In the prior art, the mode-input terminal (XMDI) and the mode-output terminal (XMDO) are required for determining the operation mode of the driving circuit 400, and thus increased pin number and cost of the driving circuit 400 are caused.

### SUMMARY OF THE INVENTION

Therefore, the present invention provides a LED display system, in which no specific pin is required for determining the operation mode.

The present invention provides a LED display system, comprising: a display controller comprising an output port having a first output terminal and a second output terminal; a plurality of LED sets; and a plurality of driving circuits, coupled in series and coupled between the display controller and the plurality of LED sets, respectively, each of the driving circuits comprising a first signal-input terminal, a first signal-output terminal, a second signal-input terminal, and a second signal-output terminal, wherein the first signal-input terminal of a first one of the driving circuits is coupled to the first output terminal of the display controller, the second signal-input terminal of the first one of the driving circuits is coupled to the second output terminal of the display controller. The display controller asserts a transition period for switching the driving circuits from a first operation mode to a second operation mode by manipulating a first signal outputted to the driving circuits through the first output terminal.

The present invention also provides a mode-determining method of a LED display system The LED display system includes a display controller, a plurality of LED sets and a plurality of driving circuits coupled in series, respectively coupled to the plurality of LED sets, and further coupled to the display controller via a data-output terminal and a clock-output terminal. The method comprises steps of: detecting whether a mode-change-notifying period is asserted by the display controller according to a first signal transmitted through the clock-output terminal; entering a mode-determining period following the mode-change-notifying period; and determining an operation mode of the driving circuits according to a pulse number of the first signal counted in the mode-determining period.

The present invention further provides a driving circuit for use in a LED display system to drive a LED set coupled thereto, comprising: a clock-input terminal; a clock buffer coupled to the clock-input terminal; a clock-output terminal coupled to the clock buffer; a data-input terminal; a first switch circuit coupled to the data-input terminal; a shift register coupled to the first switch circuit; a data buffer coupled to the first switch circuit; a second switch circuit coupled to the shift register and the data buffer; a data-output terminal coupled to the second switch circuit; a switching-control unit, coupled to the shift register, from which a driving current is outputted to the LED set according to an image data inputted through the data-input terminal, temporarily stored in the shift register, and then shifted to the switching-control unit; a configuration-control unit, coupled to the shift register, for setting the driving circuit according to a configuration data inputted through the data-input terminal and then shifted to the configuration-control unit; a detection-control unit, coupled to the shift register, from which a status data is outputted to be stored in the shift register; and a mode-detecting unit, coupled to the data-input terminal and the clock-input terminal and controlling the first switch circuit, the second switch circuit, the switching-control unit, the configuration-control unit, and the detection-control unit according to a first signal inputted through the clock-input terminal and a second signal inputted through the data-input terminal for entering a selected operation mode.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic diagram illustrating a very large scale of LED display system;

FIG. 2 is a functional block diagram schematically illustrating a LED display system;

FIG. 3 is functional block diagram schematically illustrating a single loop of a LED display system according to prior art;

FIG. 4 is a functional block diagram of a driving circuit according to prior art;

FIG. 5 is a functional block diagram schematically illustrating a single loop of a LED display system according to an embodiment of the present invention;

FIG. 6 is a waveform diagram schematically illustrating signal variations occurring when changing modes;

FIG. 7 is a functional block diagram of a driving circuit according to an embodiment of the present invention; and

FIG. 8 is a functional block diagram of a mode-detecting unit according to an embodiment of the present invention.

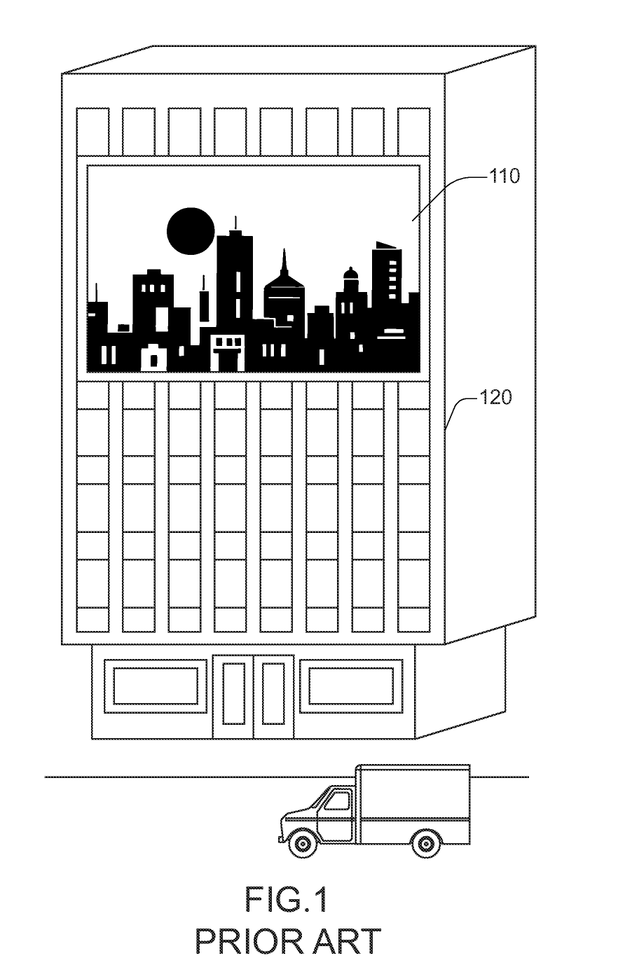

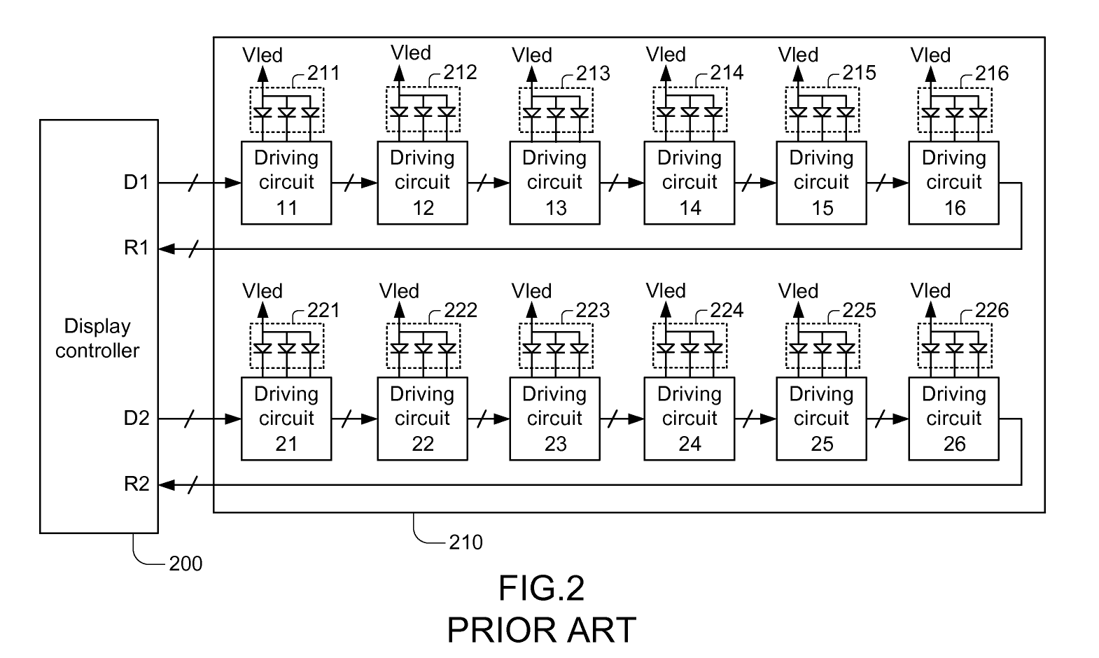

### DETAILED DESCRIPTION OF PREFERRED EMBODIMENTS

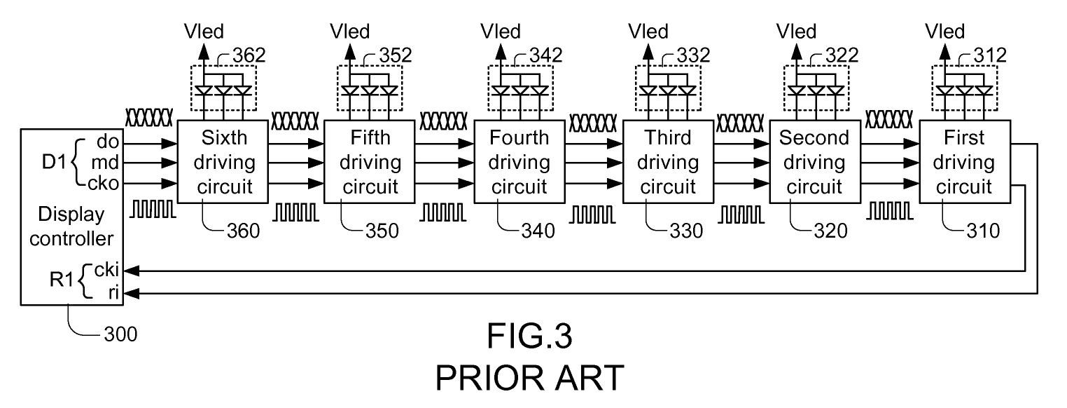

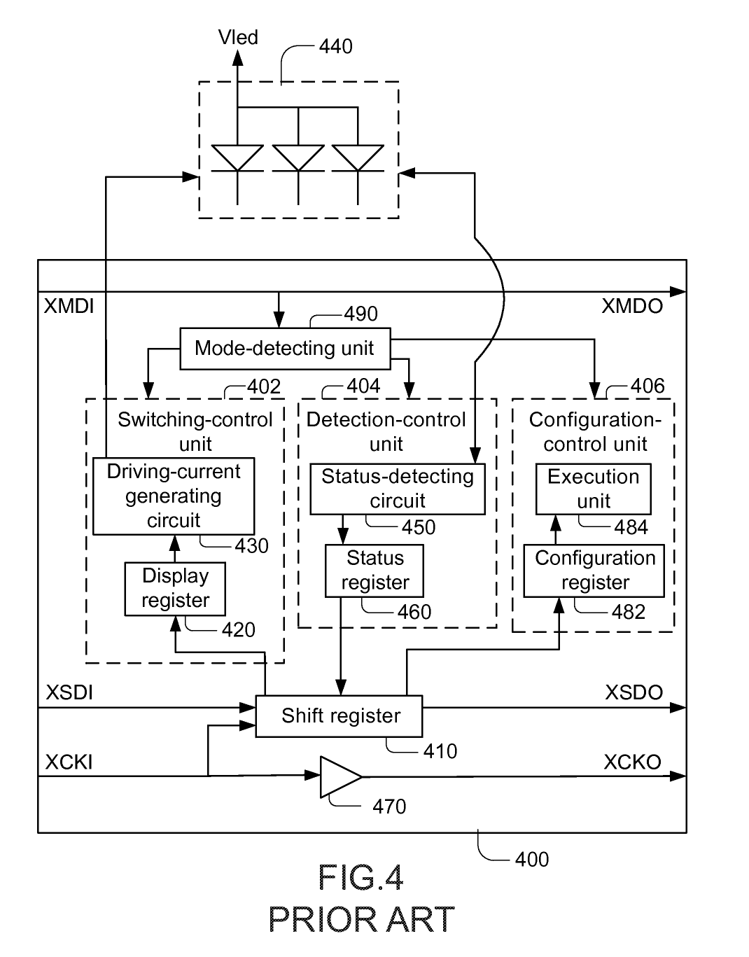

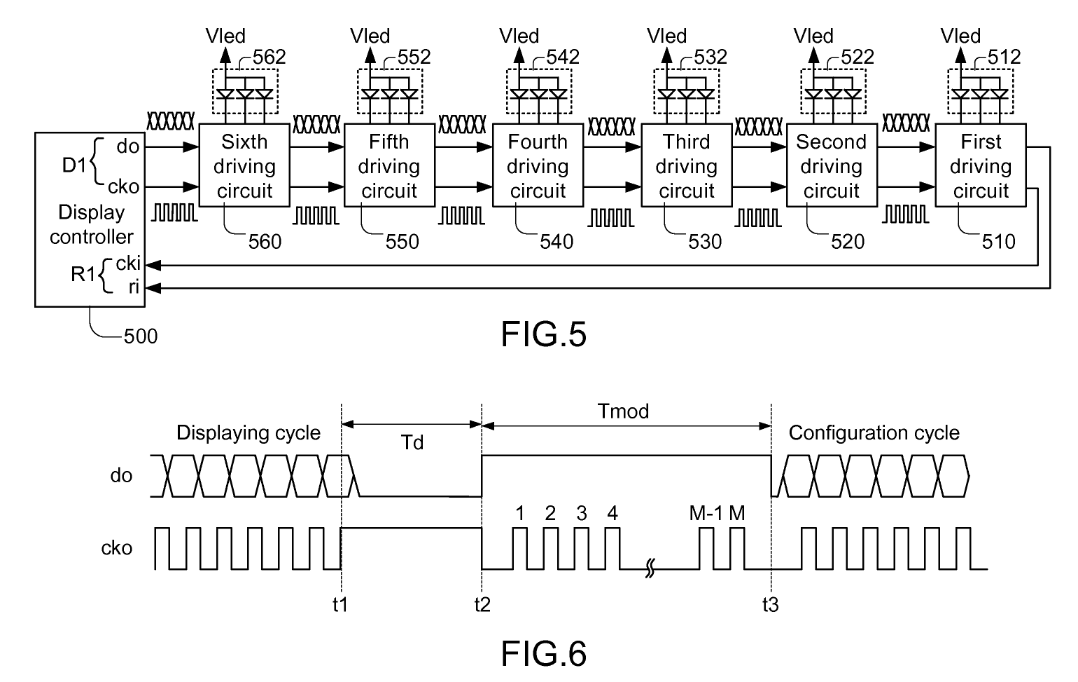

FIG. 5 is a block diagram illustrating the electric connection between a display controller and driving circuits in a LED display system according to an embodiment of the present invention. Compared to the prior-art display controller 300 depicted in FIG. 3, the mode-output terminal (md) is omitted from the first output port (D1) of the display controller 500, which only includes a data-output terminal (do) and a clock-output terminal (cko) in this embodiment; wherein the data-output terminal (do) is used for outputting the image data or the configuration data to the driving circuits 510˜560, and the clock-output terminal (cko) is used for outputting the clock signal to the driving circuits 510˜560.

Instead of determining the operation mode of the driving circuits according to the mode signal in the prior art, the operation mode of the driving circuits 510˜560 of the present invention is determined by the signals outputted through the data-output terminal (do) and the clock-output terminal (cko). Between two operation cycles, a transition period including a mode-change-notifying period and a mode-determining period is provided. FIG. 6 schematically exemplifies two signals outputted through the data-output terminal (do) and the clock-output terminal (cko), which are referred to for determining the transition period.

Take a transition period between a displaying cycle and a configuration cycle as an example. Please refer to FIGS. 5 and 6, the driving circuits 510˜560 have been operating in the displaying mode before a time point t1. The image data outputted through the data-output terminal (do) of the display controller 500 are shifted to the driving circuits 510˜560 in response to the clock signal which is outputted through the clock-output terminal (cko) in the displaying cycle.

At the time point t1 when the display controller 500 is about to switch operation modes, the mode-change-notifying period starts. The clock signal outputted through the clock-output terminal (cko) is pulled up to a high level. Meanwhile, output of new image data is suspended and thus the data signal outputted through the data-output terminal (do) is at a low level.

The duration (Td) from the time point t1 to a time point t2 is defined as the mode-change-notify period. The clock signal will stay high and the data signal will stay low in the entire duration (Td) of the mode-change-notifying period. Accordingly, once the driving circuits 510˜560 detect a high-level clock signal is outputted through the clock-output terminal (cko) and lasts for the duration (Td), it is realized that the display controller 500 is about to switch operation modes, and the driving circuits 510˜560 are prepared to change modes.

At the time point t2 when the data signal outputted through the data-output terminal (do) is pulled up to a high level and the clock signal outputted through the clock-output terminal (cko) toggles, the mode-determining period starts, indicating which operation mode the driving circuits 510˜560 is to enter.

The duration (Tmod) from the time point t2 to a time point t3 is defined as the mode-determining period. The data signal outputted through the data-output terminal (do) will stay high for the duration (Tmod). Meanwhile, a pulse number of the clock signal outputted through the clock-output terminal (cko) is calculated. According to an embodiment of the present invention, the pulse numbers vary with the operation mode that the driving circuits 510˜560 are to enter. Therefore, the coming operation mode can be realized by counting the pulse number of the clock signal. For example, as illustrated in FIG. 6, M pulses of the clock signal counted in the mode-determining period represent the configuration mode. Accordingly, the data outputted through the data-output terminal (do) after the time point t3 are the configuration data.

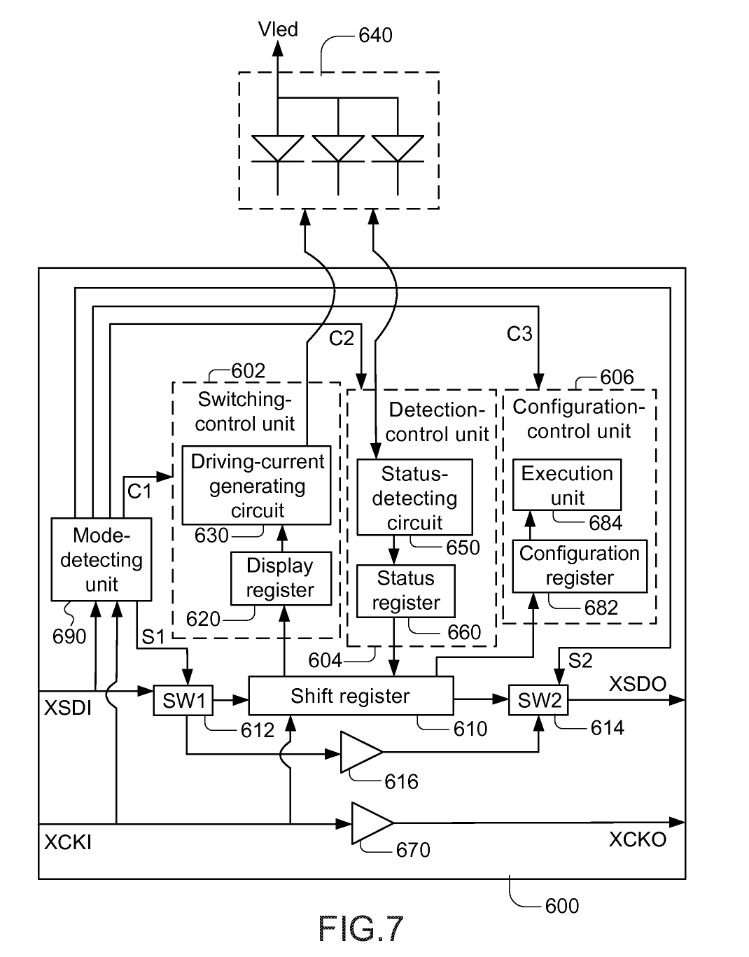

FIG. 7 is a block diagram schematically illustrating a driving circuit according to an embodiment of the present invention, which is applicable to the LED display system described above, serving as one of the driving circuits 510˜560 of FIG. 5.

The driving circuit 600, for controlling the LED set 640, includes a shift register 610, a first switch circuit (SW1) 612, a second switch circuit (SW2) 614, a data buffer 616, a switching-control unit 602, a detection-control unit 604, a configuration-control unit 606, a clock buffer 670, and a mode-detecting unit 690. The switching-control unit 602 includes a display register 620 and a driving-current generating circuit 630. The detection-control unit 604 includes a status register 660 and a status-detecting circuit 650. The configuration-control unit 606 includes a configuration register 682 and an execution circuit 684. The LED set 440 includes a single LED or a plurality of LEDs emitting light with different colors, e.g. red, green, or blue light.

The driving circuit 600 further includes a data-input terminal (XSDI), a clock-input terminal (XCKI), a data-output terminal (XSDO), and a clock-output terminal (XCKO); wherein the data-input terminal (XSDI) and the clock-input terminal (XCKI) are electrically connected to the data-output terminal (XSDO) and the clock-output terminal (XCKO) of a previous-stage driving circuit, respectively. The data-input terminal (XSDI) of the driving circuit 600 is used for receiving image data, configuration data, or status data which is shifted thereto from the previous-stage driving circuit. The data-output terminal (XSDO) of the driving circuit 600 is used for outputting therethrough image data, configuration data, or status data to next-stage driving circuit. The clock-input terminal (XCKI) of the driving circuit 600 is used for receiving the clock signal which is transmitted thereto from the previous-stage driving circuit. The clock-output terminal (XCKO) of the driving circuit 600 is used for outputting therethrough the clock signal to the next-stage driving circuit. The mode-detecting unit 690 is coupled to the data-input terminal (XSDI) and the clock-input terminal (XCKI), and determines the operation mode according to the signals outputted by the display controller through the data-output terminal (do) and the clock-output terminal (cko). According to the operation mode, the switching-control unit 602, a detection-control unit 604 or a configuration-control unit 606 is selectively enabled by way of a first control signal (C1), a second control signal (C2) or a third control signal (C3), respectively. The first switch circuit (SW1) 612 and the second switch circuit (SW2) 614 are controlled by the mode-detecting unit 690 by way of a first switch signal (S1) and a second switch signal (S2), respectively, so as to have a conducting state corresponding to the operation mode.

The clock-input terminal (XCKI) is electrically connected to the clock-output terminal (XCKO) via the clock buffer 670. The data-input terminal (XSDI) is electrically connected to the first switch circuit (SW1) 612. The first switch circuit (SW1) 612 is electrically connected to the shift register 610 and the data buffer 616. The shift register 610 and the data buffer 616 are electrically connected to the second switch circuit (SW2) 614. The second switch circuit (SW2) 614 is electrically connected to the data-output terminal (XSDO).

It is to be noted that the driving circuit 600 counts a number of pulses occurring in the clock signal inputted through the clock-input terminal (XCKI) to realize the operation mode; and meanwhile, the data signal inputted through the data-input terminal (XSDI) is not processed by the switching-control unit 602 or the configuration-control unit 606. Therefore, in the embodiment of the present invention, the first switch circuit (SW1) 612 and the second switch circuit (SW2) 614 are controlled by the mode-detecting unit 690 to have the signal inputted through the data-input terminal (XSDI) transmitted to the data-output terminal (XSDO) via the data buffer 616 without via the shift register 610 in the mode-determining period. Otherwise, the first switch circuit (SW1) 612 and the second switch circuit (SW2) 614 are controlled by the mode-detecting unit 690 to have the data (image data, configuration data, or status data) inputted through the data-input terminal (XSDI) shifted to the data-output terminal (XSDO) sequentially via the shift register 610.

As mentioned above, the operation mode of the driving circuit 600 is determined by the mode-detecting unit 690 at the end of the mode-determining period, and then associated functions of the driving circuit 600 are executed based on the new operation mode. For example, if the new operation mode of the driving circuit 600 is determined to be the displaying mode, the switching-control unit 602 is enabled by the mode-detecting unit 690 by way of the first control signal (C1). Then the corresponding image data is shifted to the shift register 610 via the first switch circuit (SW1) 612, and then sequentially transmitted to the display register 620 and the driving-current generating circuit 630. According to the image data, a driving current is generated and outputted to the LED set 640 from the driving-current generating circuit 630 so as to control the color and brightness of the LED set 640.

If the coming operation mode of the driving circuit 600 is determined to be the configuration mode, the configuration-control unit 606 is enabled by the mode-detecting unit 690 by way of the third control signal (C3). Then the corresponding configuration data is shifted to the shift register 610, and then sequentially transmitted to the configuration register 682 and the execution circuit 684. According to the configuration data, associated settings are performed on the driving circuit 600 by the execution circuit 684.

If the coming operation mode of the driving circuit 600 is determined to be the detecting mode, the detection-control unit 604 is enabled by the mode-detecting unit 690 by way of the second control signal (C2). Then the corresponding status data is generated by the status-detect circuit 650, and then sequentially transmitted to the status register 660 and the shift register 610. The status data is generated by the status-detecting circuit 650 in response to open-circuit and/or short-circuit detection of the LED set 640, temperature and/or error detection of the driving circuit 600, etc. According to the status data shifted to the display controller through the data-output terminal (XSDO) of the driving circuit 600, the operation conditions of the LED set 640 and the driving circuit 600 can be realized by the display controller.

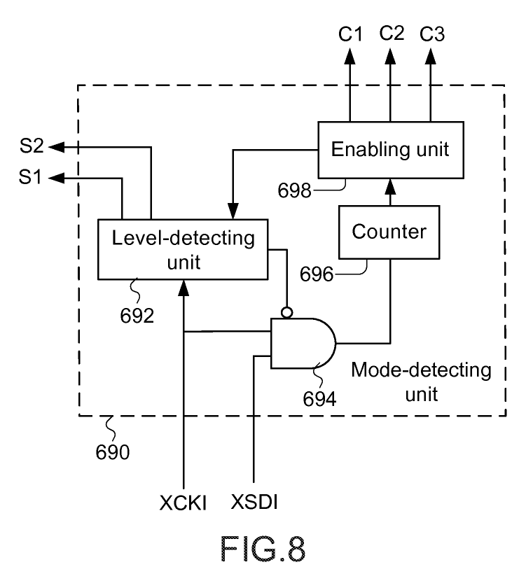

FIG. 8 is a block diagram schematically illustrating a mode-detecting unit according to an embodiment of the present invention, which is applicable to the driving circuit 600 of FIG. 7. The mode-detecting unit 690 includes a level-detecting unit 692, an AND gate 694, a counter 696, and an enabling unit 698. The level-detecting unit 692, electrically connected to the clock-input terminal (XCKI), is used for detecting whether there is a constant level, e.g. a high level, of the clock signal lasting for the duration (Td) at the clock-input terminal (XCKI). The two input terminals of the AND gate 694 are respectively electrically connected to the data-input terminal (XSDI) and the clock-input terminal (XCKI).

If there is a high-level signal lasting for the duration (Td) detected at the clock-input terminal (XCKI) by the level-detecting unit 692, it is realized that the mode-determining period asserted by the display controller will follow soon. Since the AND gate 694 is enabled, and the first switch signal (S1) and the second switch signal (S2) are respectively outputted to the first switch circuit (SW1) 612 and the second switch circuit (SW2) 614, the signal inputted through the data-input terminal (XSDI) can be transmitted to the data-output terminal (XSDO) via the data buffer 616 without via the shift register 610 in the mode-determining period.

Accordingly, the signal at the data-input terminal (XSDI) is at a high level and kept high for duration Tmod in the mode-determining period. Meanwhile, pulses of the clock signal are sequentially transmitted to the AND gate 694 so that the signal at the output terminal of the AND gate 694 is identical to the clock signal inputted to the AND gate 694 through the clock-input terminal (XCKI).

The counter 696, electrically connected to the output terminal of the AND gate 694, is used for counting the number of pulses of the clock signal at the clock-input terminal (XCKI) in the mode-determining period. The counted pulse number is then transmitted to the enabling unit 698. The first control signal (C1), the second control signal (C2), or the third control signal (C3) are selectively outputted to the switching-control unit 602, the detection-control unit 604, or the configuration-control unit 606, respectively, from the enabling unit 698 based on the pulse number so as to switch the driving circuit 600 to the determined operation mode.

For example, if the coming operation mode is determined to be the configuration mode based on the pulse number, the configuration-control unit 606 is enabled by the enabling unit 698 by way of the third control signal (C3), the level-detecting unit 692 is then informed by the enabling unit 698 to respectively output the first switch signal (S1) and the second switch signal (S2) to control the conducting states of the first switch circuit (SW1) 612 and the second switch circuit (SW2) in order that the configuration data from the display controller can be transmitted to the shift register 610.

In view of the going, by determining the operation mode of the driving circuit based on the signals inputted through the data-input terminal (XSDI) and the clock-input terminal (XCKI), there is no need using any additional pin, e.g. the mode-input terminal (XSMI) and the mode-output terminal (XMDO) disposed in the prior-art driving circuit.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A LED display system, comprising:
a display controller comprising an output port having a first output terminal and a second output terminal;
a plurality of LED sets; and
a plurality of driving circuits, coupled in series and coupled between the display controller and the plurality of LED sets, respectively, each of the driving circuits comprising a first signal-input terminal, a first signal-output terminal, a second signal-input terminal, and a second signal-output terminal, wherein the first signal-input terminal of a first one of the driving circuits is coupled to the first output terminal of the display controller, the second signal-input terminal of the first one of the driving circuits is coupled to the second output terminal of the display controller;
wherein the display controller asserts a transition period for switching the driving circuits from a first operation mode to a second operation mode by manipulating a first signal outputted to the driving circuits through the first output terminal.

2. The LED display system according to claim 1 wherein each of the first and second operation modes is selected from a displaying mode, a configuration mode and a detecting mode.

3. The LED display system according to claim 1 wherein the transition period includes a mode-change-notifying period and a mode-determining period following the mode-change-notifying period, and the first signal is kept at a first level for a first duration in the mode-change-notifying period.

4. The LED display system according to claim 3 wherein the first level is a high level.

5. The LED display system according to claim 1 wherein the transition period includes a mode-change-notifying period and a mode-determining period following the mode-change-notifying period, and the second signal is kept at a second level for a second duration, and a pulse number of the first signal is counted in the mode-determining period.

6. The LED display system according to claim 5 wherein the second level is a high level.

7. The LED display system according to claim 5 wherein the second operation mode is determined according to the counted pulse number.

8. The LED display system according to claim 1 wherein the first signal-input terminal is a clock-input terminal, the first signal-output terminal is a clock-output terminal, the second signal-input terminal is a data-input terminal, and the second signal-output terminal is a data-output terminal.

9. The LED display system according to claim 8 wherein each of the driving circuits comprises:
the clock-input terminal;
a clock buffer coupled to the clock-input terminal;
the clock-output terminal coupled to the clock buffer;
the data-input terminal;
a first switch circuit coupled to the data-input terminal;
a shift register coupled to the first switch circuit;
a data buffer coupled to the first switch circuit;
a second switch circuit coupled to the shift register and the data buffer;
the data-output terminal coupled to the second switch circuit;
a switching-control unit, coupled to the shift register, from which a driving current is outputted to a corresponding one of the LED sets according to an image data inputted through the data-input terminal, temporarily stored in the shift register, and then shifted to the switching-control unit;
a configuration-control unit, coupled to the shift register, for setting the driving circuit according to a configuration data inputted through the data-input terminal and then shifted to the configuration-control unit;
a detection-control unit, coupled to the shift register, from which a status data is outputted to be stored in the shift register; and
a mode-detecting unit, coupled to the data-input terminal and the clock-input terminal for controlling the first switch circuit, the second switch circuit, the switching-control unit, the configuration-control unit, and the detection-control unit according to the first and second signals.

10. The LED display system according to claim 9 wherein the switching-control unit comprises:
a display register, coupled to the shift register, for temporarily storing the image data inputted from the shift register; and
a driving-current generating circuit, coupled to the display register, for generating the driving current to be outputted to the corresponding one of the plurality of LED sets.

11. The LED display system according to claim 9 wherein the configuration-control unit comprises:
a configuration register, coupled to the shift register for temporarily storing the configuration data inputted from the shift register; and
an execution circuit, coupled to the configuration register for setting the driving circuit according to the configuration data.

12. The LED display system according to claim 9 wherein the detection-control unit comprises:
a status-detecting circuit for performing a detecting operation and generating the status data; and
a status register, coupled to the status-detecting circuit and the shift register for temporarily storing and then transmitting the status data to the shift register.

13. The LED display system according to claim 9 wherein the mode-detecting unit comprises:
a level-detecting unit, coupled to the clock-input terminal for detecting a level of the first signal at the clock-input terminal and determining that a mode-change-notifying period of the transition period is entered when the first signal is kept at the first level for the first duration;
an AND gate having an enabling terminal coupled to the level-detecting unit and two input terminals respectively coupled to the data-input terminal and the clock-input terminal; wherein the AND gate is enabled by the level-detecting unit in a mode-determining period of the transition period, following the mode-change-notifying period, thereby controlling a conducting state of the first switching circuit and the second switching circuit;
a counter, coupled to an output terminal of the AND gate for counting a pulse number of a signal outputted through the output terminal of the AND gate; and
an enabling unit, coupled to the counter for selectively enabling one of the switching-control unit, the configuration-control unit and the detection-control unit according to the counted pulse number.

14. A mode-determining method of a LED display system, the LED display system including a display controller, a plurality of LED sets and a plurality of driving circuits coupled in series, respectively coupled to the plurality of LED sets, and further coupled to the display controller via a data-output terminal and a clock-output terminal, the method comprising steps of:
detecting whether a mode-change-notifying period is asserted by the display controller according to a first signal transmitted through the clock-output terminal;
entering a mode-determining period following the mode-change-notifying period; and
determining an operation mode of the driving circuits according to a pulse number of the first signal counted in the mode-determining period.

15. The method according to claim 14 wherein the operation mode is selected from a displaying mode, a configuration mode, or a detecting mode.

16. The method according to claim 14 wherein the mode-change-notifying period is detected when the first signal is kept at a first level for a first duration.

17. The method according to claim 16 wherein the first level is a high level.

18. The method according to claim 14 wherein a second signal transmitted through the data-output terminal is kept at a second level for a second duration in the mode-determining period.

19. The method according to claim 18 wherein the second level is a high level.

20. A driving circuit for use in a LED display system to drive a LED set coupled thereto, comprising:
a clock-input terminal;
a clock buffer coupled to the clock-input terminal;
a clock-output terminal coupled to the clock buffer;
a data-input terminal;
a first switch circuit coupled to the data-input terminal;
a shift register coupled to the first switch circuit;
a data buffer coupled to the first switch circuit;
a second switch circuit coupled to the shift register and the data buffer;
a data-output terminal coupled to the second switch circuit;
a switching-control unit, coupled to the shift register, from which a driving current is outputted to the LED set according to an image data inputted through the data-input terminal, temporarily stored in the shift register, and then shifted to the switching-control unit;
a configuration-control unit, coupled to the shift register, for setting the driving circuit according to a configuration data inputted through the data-input terminal and then shifted to the configuration-control unit;
a detection-control unit, coupled to the shift register, from which a status data is outputted to be stored in the shift register; and
a mode-detecting unit, coupled to the data-input terminal and the clock-input terminal and controlling the first switch circuit, the second switch circuit, the switching-control unit, the configuration-control unit, and the detection-control unit according to a first signal inputted through the clock-input terminal and a second signal inputted through the data-input terminal for entering a selected operation mode.
